(19) United States
(12) Patent Application Publication
(10) Pub. No.: US 2006/0194190 A1
(43) Pub. Date: Aug. 31, 2006

(54) Toilet-training instruction device and method

(76) Inventors: Kristen J. Riley, Highland Village, TX (US); Lisa J. Wood, Highland Village, TX (US)

Correspondence Address: GRADY K. BERGEN, 3333 LEE PARKWAY, SUITE 600, DALLAS, TX, 75219, US

(21) Appl. No.: 11/065,751

(22) Filed: Feb. 25, 2005

(51) Int. Cl. G09B 25/00

(52) U.S. Cl. 434/365

(57) ABSTRACT

An instruction device and method of instruction for small children during toilet training to facilitate determining the amount of toilet paper to use to avoid over usage is provided by providing a roll of toilet paper that is mounted on a support structure adjacent a toilet. An instruction panel is positioned on a wall or other structure in proximity to the mounted roll of toilet paper. The instruction panel has indicia thereon to indicate a preselected length that may be compared to an unrolled length of the toilet paper.

### TECHNICAL FIELD

The invention relates generally to instructional devices and methods for children.

### BRIEF DESCRIPTION OF THE DRAWINGS

For a more complete understanding of the present invention, reference is now made to the following description taken in conjunction with the accompanying figures, in which:

FIG. 1 is a front elevational view of an instructional device constructed in accordance with an embodiment of the invention;

FIG. 2 is a side elevational view of the instructional device of FIG. 1;

FIG. 3 is a rear elevational view of the instructional device of FIG. 1; and

FIG. 4 is a front perspective view of the instructional device of Figure, shown in use with a roll of toilet paper.

### DETAILED DESCRIPTION

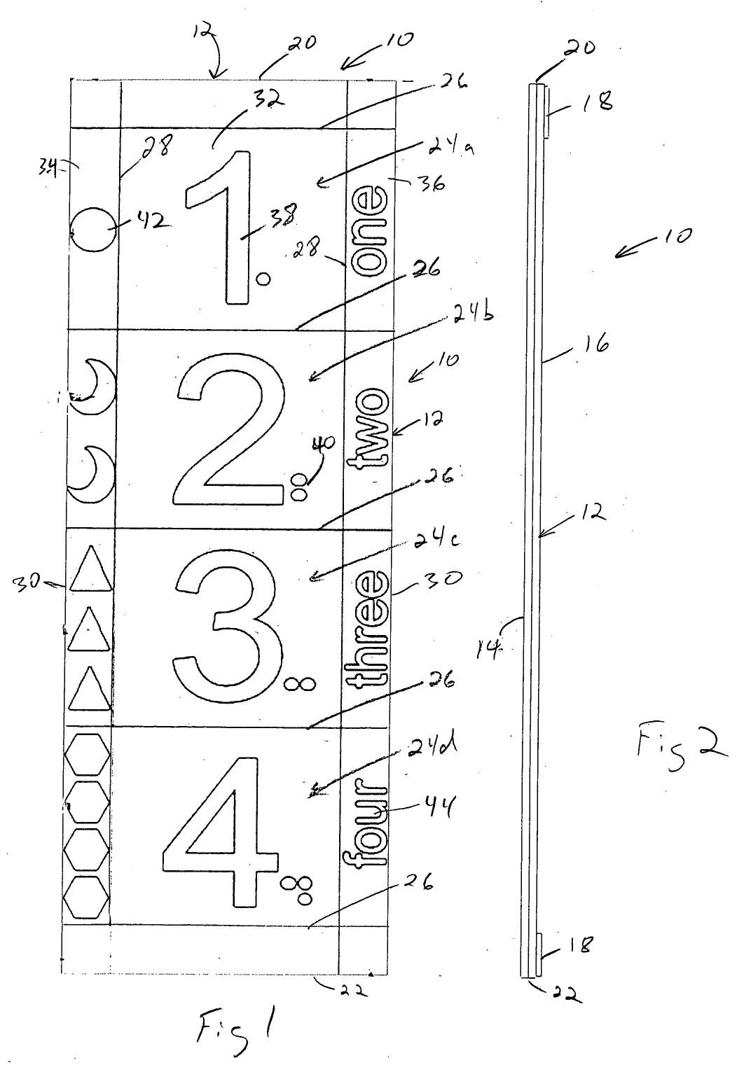

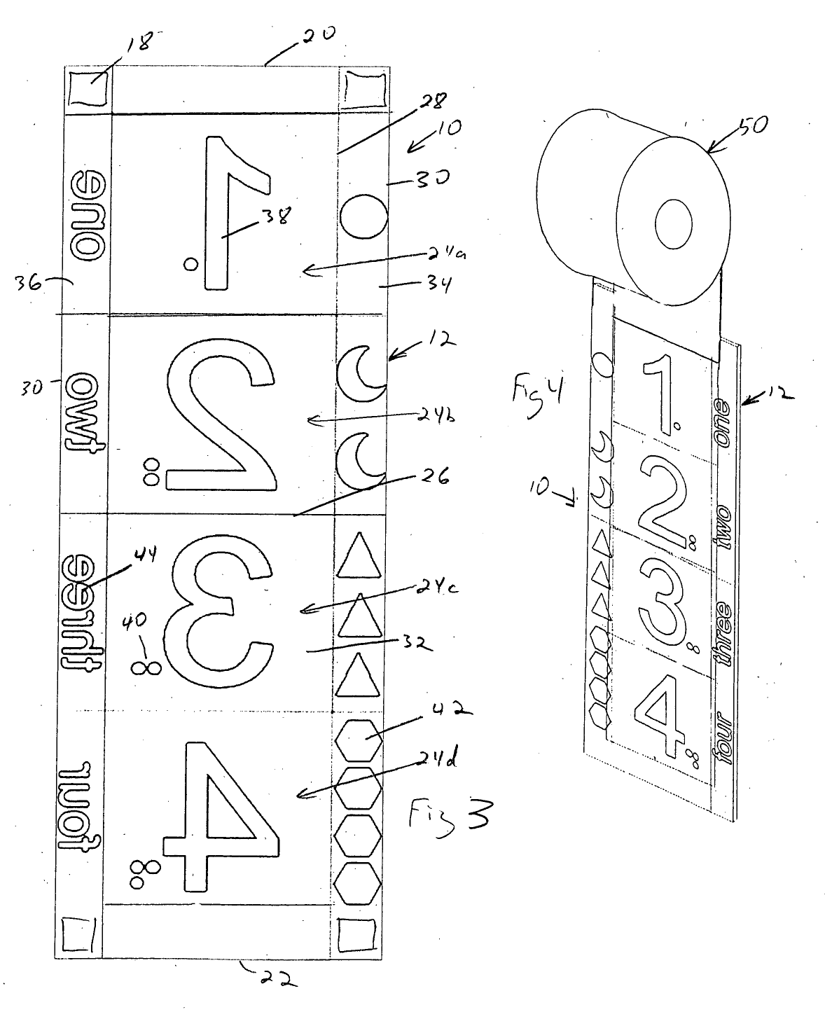

Referring to FIG. 1, an instructional device 10 for assisting small children during toilet training is shown. The device 10 may be formed from a generally planar body or panel 12. The panel 12 may have an elongated, rectangular shape, although it may have other shapes as well. The body or panel 12 may be formed from a variety of different materials, both rigid and flexible, including metal, wood, plastic, fiberglass and other composite materials, cardboard, paper, plastic or other polymeric materials, etc. All or a portion of the panel 12 may be formed from an optically transparent or substantially transparent material. An example of a suitable material is a clear acrylic material.

As shown in FIG. 2, the panel 12 may be relatively thin so that it has a low side profile and can be positioned against or adjacent a wall or upright surface of a support structure. The panel 12 has a forward surface 14 and a rearward surface 16. Fasteners 18 may be provided with the panel 12. The fasteners 18 may include any conventional fastener such as those known to those skilled in the art. Such fasteners may include, but are not limited to, nails, screws, magnets, hook and loop fasteners (egs. Velcro® fasteners), tape, hooks, wires, etc. A suitable fastener is a Velcro® hook and loop fastener in which at least one of the hook and loop fastener components may be secured (such as by means of adhesive backing) to the rearward surface 16 near the upper edge 20 and lower edge 22 of the panel 12, as shown, or other areas, as well. The other of the corresponding hook and loop fastener components may be secured to the wall or other structure to which the panel 12 may be mounted. Such releasable fasteners allow the panel 12 to be readily removed and replaced, if desired.

The panel 12 is provided with various indicia. The indicia may be permanently printed or other wise formed on the panel 12. In one embodiment, the indicia may be printed, such as by screen printing, on the rearward side 16 of the panel 12 so that it is protected and is not damaged or altered when cleaning the front surface 14. The indicia may be slightly raised or recessed from the surface of the panel 12. The indicia may also be removably attached to the panel.

In the embodiment shown, the panel 12 is divided into four sections 24a-24d that are longitudinally spaced apart. The sections 24a-24d may be indicated by various means. This may include indicia in the form of a series of transverse lines of demarcation 26 that extend across or substantially across the width of the panel 12. The lines 26 may be parallel to one another and be longitudinally spaced apart.

The length of each section 24 may be equivalent or substantially equivalent to a standard length (egs. 4-5 inches) of a sheet or square of toilet paper. The number of sections 24 provided on the panel 12 may be selected to provide a total length equal or approximate to an appropriate length of toilet paper (egs. 3-5 sheets) to avoid over usage and to facilitate prevention of clogging of the toilet bowl.

A pair of longitudinal lines 28 of demarcation may also be optionally provided on the panel 12. The longitudinal lines 28 may be laterally spaced apart a distance equivalent or substantially equivalent to the width of standard of toilet paper. The lines 28 may be laterally spaced inward from longitudinal side edges 30 of the panel 12. Alternatively, the side edges 30 may be spaced apart a distance to approximate the width of the toilet paper.

In the embodiment shown, the lines 26 and 28 and the side edges 30 define a center subsection 32 and opposite side sections 34, 36. Provided in each of the sections 32, 34, 36 may be numeric indicia representative of the number of squares or sheets of toilet paper to be used. Thus, the numeric indicia may correspond to the consecutive whole numbers 1, 2, 3, 4, etc., with each section 24 having different numeric indicia corresponding to one of the numbers 1, 2, 3 or 4, thus numerically designating each section 24.

Referring to FIG. 1, the center section 32 may be provided with Roman or Arabic numeral indicia 38. Other indicia may also be provided in the section 32. In the embodiment shown, Braille indicia 40, which may be raised or recessed so that it may be felt when touched, corresponding to the number designation of each section 24 is provided.

The side section 34 is provided with sets of non-numeral objects 42, with the number of objects 42 in each set representing the designated number of the section 24. Thus, for the first section 24a, there is only one object 42. In the second section 24b there is a set of two objects 42, and so forth. The objects 42 may also be of recognizable shapes corresponding to or representing various actual objects, such as trees, flowers, fish, birds, animals, insects, boats, vehicles, airplanes, buildings, spacecraft, stars, etc. In the embodiment shown, a crescent moon shape is shown for the object 42 of section 24b, which provides a fun or entertaining theme reminiscent of the moon shape provided on outhouses and the like.

Other shaped objects may be provided to facilitate instruction. Thus, in the embodiment shown, in the next to the last or lower section 24c, a set of three triangular shaped objects 42 oriented as a traffic “yield” sign to indicate slowing or cautionary instruction. In the last section 24d, a set of hexagonal-shaped objects 42 representative of a traffic “stop” sign is provided to indicate the user should stop unrolling the roll of toilet paper.

Verbally written numeral indicia 44 may also be provided in each of the subsections 36 representing the numeral designation of each section 24, as shown.

All or some of the indicia provided in each section 24 or portions of each section 24 may be provided with coloration. The coloration of each section may correspond to the sequential lighting of a traffic light, to facilitate instruction related to traffic signals. Thus, the section 24a may have green coloration to indicate it is permissible to proceed. The intermediate section 24b may have a neutral color, such as blue. The next to the last section, section 24c, may utilize the color yellow to indicate caution or “slow down.” The last or final section 24d may utilize the color red to indicate “stop.”

Other non-numeric objects or ornamentation, of the same or different coloration, may be provided on the panel or within each of the sections. The aforementioned indicia may also be located at different positions as those that have been described.

Referring to FIG. 4, in use, the panel 12 is positioned or mounted in proximity to a roll of toilet paper 50, which may be mounted on a support structure, such as a bathroom wall, cabinet, etc., adjacent to or near a toilet. The panel 12 may be secured to the wall or other support structure so that the upper or top portion of the panel 12 is located immediately beneath or slightly underlies the roll of toilet paper 50. The panel 12 may be positioned so that as the toilet paper is unrolled downward, the length of unrolled toilet paper is centered between the longitudinal lines 28 or side edges 30. In certain instances, it may be preferable to orient the roll of toilet paper so that it unrolls from the back, as shown, so that the unrolled paper locates closer to the panel 12.

As the toilet paper is unrolled, the sequential sections 24 indicate to the child how much paper should be used. When the last or lowermost section 24d is covered by the unrolled toilet paper, the child knows that an appropriate amount of the toilet paper has been unrolled for use.

The device 10 can be used as part of a kit that includes the device 10, written instructions on how to use the device and a book or other device that may include a place for the child's name, photo, and toilet training accomplishments. These may be packaged together in the same packaging. The device may also be initially provided with the panel with all or some of the indicia being initially detached. This allows the child the opportunity to attach the provided indicia to create his or her own design, as well as provide an instructional and entertaining activity. The detached indicia may be attached to the panel with adhesive, Velcro® fasteners or other suitable fasteners.

The device 10 provides a variety of useful, instructional or educational functions. The device can be used in a variety of different environments, including homes, schools, daycares, hospitals, etc. The device is easy for children to understand. It makes toilet training fun and entertaining. The device facilitates instructing the child in using an appropriate amount of toilet paper. This reduces the amount of toilet paper the child may use, preventing clogged toilets and avoiding waste. It also provides a means for teaching numbers, colors, counting, shapes, reading and for understanding traffic signs and signals.

While the invention has been shown in only some of its forms, it should be apparent to those skilled in the art that it is not so limited, but is susceptible to various changes and modifications without departing from the scope of the invention. For instance, although a separate panel has been shown and described, which may be mounted or secured to a wall or other structure, the panel may instead be formed by painting, printing or otherwise forming the indicia directly on the wall or structure to which the panel would otherwise be mounted. Accordingly, it is appropriate that the appended claims be construed broadly and in a manner consistent with the scope of the invention.

We claim:

1. A method of instructing small children during toilet training to facilitate determining the amount of toilet paper to use to avoid over usage, the method comprising:
providing a roll of toilet paper formed from a continuous length of flushable tissue that is divided into sheets by a plurality of longitudinally spaced apart lines of perforations;
mounting the roll of toilet paper on a support structure adjacent to a toilet;
providing an instruction panel on a wall or other structure in proximity to the mounted roll of toilet paper, the instruction panel having indicia thereon to indicate a preselected length that may be compared to an unrolled length of the toilet paper.

2. The method of claim 1, wherein:
the indicia includes a series of demarcations to divide the instruction panel into sections representative of individual sheets of the toilet paper.

3. The method of claim 1, wherein:
the indicia includes numeric representations indicative of a number of sheets of toilet paper.

4. The method of claim 3, wherein:
the numeric representations include consecutive numbers.

5. The method of claim 3, wherein:
the numeric representations are selected from Arabic numerals, Roman numerals, sets of non-numeral objects and verbally written numerals.

6. The method of claim 1, wherein:
the indicia demarcates different sections representative of individual sheets of toilet paper and wherein each section is provided with indicia of different colors.

7. The method of claim 1, wherein:
the indicia demarcates different sections representative of individual sheets of toilet paper and wherein each section is provided with indicia of different colors that are used in a sequence of green, yellow and red.

8. The method of claim 1, wherein:
the panel includes fasteners for fastening the panel to the wall or other structure.

9. The method of claim 1, wherein:
the panel is formed from an optically transparent material.

10. A device for instructing small children during toilet training to facilitate determining the amount of toilet paper to use to avoid over usage, the roll of toilet paper being mounted on a support structure adjacent a toilet, the device comprising:
an instruction panel for positioning on a wall or other structure in proximity to the mounted roll of toilet paper, the instruction panel having indicia thereon to indicate a preselected length that may be compared to an unrolled length of the toilet paper.

11. The device of claim 10, wherein:
the indicia includes a series of demarcations to divide the instruction panel into sections representative of individual sheets of the toilet paper.

12. The device of claim 10, wherein:
the indicia includes numeric representations indicative of a number of sheets of toilet paper.

13. The device of claim 12, wherein:
the numeric representations are for consecutive numbers.

14. The device of claim 12, wherein:
the numeric representations are selected from Arabic numerals, Roman numerals, sets of non-numeral objects and verbally written numerals.

15. The device of claim 10, wherein:
the indicia demarcates different sections representative of individual sheets of toilet paper and wherein each section is provided with indicia of different colors.

16. The device of claim 10, wherein:
the indicia demarcates different sections representative of individual sheets of toilet paper and wherein each section is provided with indicia of different colors that are used in a sequence of green, yellow and red.

17. The device of claim 10, wherein:
the panel includes fasteners for fastening the panel to the wall or other structure.

18. The device of claim 10, wherein:
the panel is formed from an optically transparent material.

19. A device for instructing small children during toilet training to facilitate determining the amount of toilet paper to use to avoid over usage, the roll of toilet paper being formed from a continuous length of flushable tissue that is divided into sheets by a plurality of longitudinally spaced apart lines of perforations, the roll of toilet paper being mounted on a support structure adjacent a toilet, the device comprising:
an instruction panel for positioning on a wall or other structure in proximity to the mounted roll of toilet paper, the instruction panel having indicia thereon to indicate a preselected length that may be compared to an unrolled length of the toilet paper, the indicia including a series of demarcations to divide the instruction panel into sections representative of individual sheets of the toilet paper, the indicia further including numeric representations indicative of a number of sheets of toilet paper, the numeric representations being for consecutive numbers that are selected from at least one of Arabic numerals, Roman numerals, sets of non-numeral objects and verbally written numerals, and wherein the indicia demarcates different sections representative of individual sheets of toilet paper and wherein each section is provided with indicia of different colors that are used in a sequence of green, yellow and red.
